(19) United States
(12) Patent Application Publication
(10) Pub. No.: US 2024/0246042 A1
(43) Pub. Date: Jul. 25, 2024

(54) METHOD FOR EMULSIFICATION USING IONIC FLUX

(71) Applicants: Purdue Research Foundation, West Lafayette, IN (US); The University of North Carolina at Chapel Hill, Chapel Hill, NC (US)

(72) Inventors: Jeffrey Edward Dick, West Lafayette, IN (US); Guillermo Sebastian Colon Quintana, West Lafayette, IN (US); Thomas Bradley Clarke, Durham, NC (US)

(73) Assignees: Purdue Research Foundation, West Lafayette, IN (US); The University of North Carolina at Chapel Hill, Chapel Hill, NC (US)

(21) Appl. No.: 18/388,359

(22) Filed: Nov. 9, 2023

Related U.S. Application Data
(60) Provisional application No. 63/440,765, filed on Jan. 24, 2023.

(51) Int. Cl. B01F 23/411; B01F 23/41

(52) U.S. Cl. CPC B01F 23/411; B01F 23/4145

(57) ABSTRACT

A method for spontaneous emulsification comprising mixing (i) an aqueous phase comprising a partitioning agent which contains a partitioning anion which determines the hydrophilicity of the partitioning agent, alone or in further combination with an electrolyte, with (ii) an oil phase comprising a phase-transfer agent, wherein the phase-transfer agent creates and promotes an interfacial flux of an anion and promotes the formation of droplets at a liquid-liquid interface of the aqueous phase and oil phase; and a method for spontaneous electro-emulsification comprising generating an ionic flux across the liquid-liquid interface by applying an electrical potential.

### CROSS-REFERENCE TO RELATED APPLICATION

This application claims priority to U.S. provisional patent application No. 63/440,765, which was filed Jan. 24, 2023, and which is hereby incorporated by reference in its entirety.

### STATEMENT OF GOVERNMENT SUPPORT

This invention was made with government support under GM138133 awarded by the National Institutes of Health. The government has certain rights in the invention.

### TECHNICAL FIELD

The present disclosure relates to a method for spontaneous emulsification by achieving and using ionic flux at a liquid-liquid interface.

### BACKGROUND

This section introduces aspects that may help facilitate a better understanding of the disclosure. Accordingly, these statements are to be read in this light and are not to be construed as admissions about what is or is not prior art.

Emulsions are important in everyday life and are critical across a broad spectrum of industries and pharmaceutical settings for drug development and manufacture. Unfortunately, emulsification requires a significant driving force for droplet dispersion. Numerous methods for emulsification have been developed.

In one method, energy can be supplied to mix two immiscible phases (e.g., water and oil) that are initially at equilibrium and form an emulsion consisting of water droplets in oil or oil droplets in water. However, unless a surface-active species is present to stabilize the droplets, droplets can rapidly coalesce as the system reverts to two bulk solutions.

Instead of supplying external energy, placing two immiscible phases together that are not in equilibrium can also induce emulsification due to the gradients in chemical potential. Methods of this type have been termed “spontaneous emulsification” or “self-emulsification,” and numerous reports have been published describing such phenomena (see, e.g., Solans, C. et al., Current Opinion in Colloid and Interface Science, 2016, 22, 88-93). These methods can be achieved with or without surfactants but require a third component besides the two immiscible phases. Such systems are called “ternary systems.” A surfactant can be used as the third component in such a system to decrease the interfacial energy sufficiently so emulsion droplets can spontaneously form. Alternatively, amphiphilic solvents or solutes that are partially soluble in both phases can induce emulsification within ranges of specific molar ratios to achieve surfactant-free emulsification. The degree of emulsification is dictated by the mass or molar ratios of the three phases and can require large amounts of amphiphilic solvents or additional organic solutes.

Therefore, there is an unmet need to develop a robust alternative to spontaneous emulsification methods which use surfactants or other large amounts of amphiphilic substances. The present disclosure provides a low-energy method to produce spontaneous stable emulsion without using large amounts of a third component, such as amphiphilic solvents or organic solutes.

### SUMMARY

Provided is a method for spontaneous emulsification. The method comprises:
mixing (i) an aqueous phase comprising a partitioning agent, which contains a partitioning anion, which determines the hydrophilicity of the partitioning agent, alone or in further combination with an electrolyte, with (ii) an oil phase comprising a phase-transfer agent, wherein the phase-transfer agent creates and promotes an interfacial flux of an anion and promotes formation of droplets at a liquid-liquid interface of the aqueous phase and the oil phase, whereupon the emulsification is spontaneously formed.

The partitioning agent used in the aqueous phase can be selected from chloroauric acid (HAuCl₄) containing AuCl₄⁻ partitioning anion, potassium thiocyanate (KSCN) containing SCN⁻ partitioning anion, and potassium ferricyanide (K₃[Fe(CN)₆]) containing Fe(CN)₆³⁻ partitioning anion. In some embodiments, the partitioning agent is HAuCl₄. The concentration of the partitioning agent in the aqueous phase can range from about 1 mM to about 10 mM (such as from about 1 mM to 10 mM or from 1 mM to about 10 mM).

The phase-transfer agent used in the oil phase can be a quaternary ammonium salt. In some embodiments, the quaternary ammonium salt is selected from tetrabutylammonium perchlorate [NBu₄][ClO₄], tetrabutylammonium hexafluorophosphate [NBu₄][PF₆], tetrabutylammonium bromide [NBu₄][Br], tetrabutylammonium chloride [NBu₄][Cl], tetraethylammonium perchlorate [NEt₄][ClO₄], and tetrahexylammonium perchlorate [NHx₄][ClO₄]. In some embodiments, the phase-transfer agent is [NBu₄][ClO₄]. The concentration of the phase transfer agent in the oil phase can range from about 10 mM to about 100 mM (such as from about 10 mM to 100 mM or from 10 mM to about 100 mM).

The oil phase can be selected from an organic solvent such as dichloroethane (DCE), dichloromethane, chloroform, or nitrobenzene. In exemplary embodiments, the oil phase is DCE.

The electrolyte used in the aqueous phase can be a salt. In exemplary embodiments, the salt is selected from inorganic halides such as potassium chloride, sodium chloride, calcium chloride, ammonium chloride, potassium iodide, sodium iodide, and sodium perchlorate.

Like chemical potential gradients, electrical potential can also create an ionic flux of anion across a liquid-liquid interface. Provided is a method for spontaneous electro-emulsification wherein the method comprises:
a. mixing (i) an aqueous phase, optionally comprising a phase-transfer agent, with (ii) an oil phase comprising at least one phase-transfer agent, wherein the aqueous phase and the oil phase each comprises an electrode connected to a conductive metal wire; and
b. applying a voltage,
wherein a voltage difference is created, which promotes an interfacial flux of an anion and promotes formation of droplets at a liquid-liquid interface of the aqueous phase and the oil phase, whereupon the spontaneous electro-emulsification is formed.

The phase-transfer agent used for electro-emulsification can be a quaternary ammonium salt selected from tetrabutylammonium perchlorate [NBu₄][ClO₄], tetrabutylammonium hexafluorophosphate [NBu₄][PF₆], tetrabutylammonium bromide [NBu₄][Br], tetrabutylammonium chloride [NBu₄][Cl], tetraethylammonium perchlorate [NEt₄][ClO₄], tetrabutylammonium tetraphenylborate [NBu₄][TPB] and tetrahexylammonium perchlorate [NHx₄][ClO₄]. The oil phase can be selected from dichloroethane, dichloromethane, chloroform, and nitrobenzene. In some embodiments, the conductive metal wire is platinum (Pt) wire.

### BRIEF DESCRIPTION OF DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 shows the optical representation of partitioning of chloroauric acid (HAuCl₄) over time. Initial concentrations consisted of an aqueous solution of 10 mM HAuCl₄ and 1M potassium chloride (KCl) (top layer), and 0.1 M tetrabutylammonium perchlorate [NBu₄][ClO₄] in 1,2-dichloroethane (DCE) (bottom layer). Images were taken at different timepoints to show the progression of partitioning over time, with a schematic representation of the partitioning process below each corresponding image. Images were taken with a 12-megapixel camera with a f/2.0 aperture.

FIG. 2 shows a method of detecting emulsion formation. Aqueous droplets containing HAuCl₄ (10 mM) and sodium chloride (NaCl, 1M) were pipetted onto a glass slide with a DCE droplet containing [NBu₄][ClO₄] (0.1 M) pipetted into the center. A cover slip was placed on top of the droplets, and transmission light microscopy showed the spontaneous emulsification and generation of DCE droplets in the aqueous phase over time.

FIG. 3 shows the methods A, B, and C used for the determination of droplet size distribution and distance measurements.

(A) is an initial image prior to measurements with ImageJ software, and the top image shows a representative droplet distribution after emulsification at the interface [HAuCl₄] (10 mM) in water, [NBu₄][ClO₄] (0.1 M) in DCE, with the bottom image showing ImageJ's region of interest (ROI) manager.

(B) is a droplet measurement process using the ROI manager, where each droplet was individually selected and hand-measured to the closest ellipse.

(C) is an image of post-measurement with ImageJ software. The top image shows all droplets identified and measured, while the bottom image shows the completed ROI for measurements.

FIG. 4 shows the light microscopy images of the aqueous phase-DCE interface, wherein the aqueous phase contains 10 mM HAuCl₄+1M NaCl, and DCE contains 0.1 M [NBu₄][ClO₄] at (A) 10 s, (B) 1 min, (C) 6 min, and (D) 11 min after initial contact of the two phases. The scale bar for all images is 50 μm. All optical micrographs were taken with a 40× NA 0.60 objective and a 500 ms exposure time.

FIG. 5 shows the histograms showing the frequency (A) and average cross-sectional area (B) of droplets identified in images (FIG. 4) as a function of distance from the interface at 10 sec, 1 min, 6 min, and 11 min after initial contact. All error bars (B) are plotted as the standard deviation about the mean for N equal to the number of droplets identified in that region (from A).

FIG. 6 shows dynamic light scattering (DLS) measurements of DCE droplets spontaneously formed in the aqueous phase when HAuCl₄ (10 mM, 10 mL) was pipetted into DCE (10 mL) containing [NBu₄][ClO₄] (0.1 M). An overhead stirrer was inserted into the aqueous phase and was used to induce convection in the aqueous phase without making contact with the liquid-liquid boundary. Droplets were collected after ten minutes of solution contact and measured for over an hour. Monomodal distributions were observed for all cases, with the droplet diameters decreasing with time.

FIG. 7 shows images for the stability of the observed emulsion over time. HAuCl₄ aqueous solution was pipetted over [NBu₄][ClO₄] DCE solution. The emulsion was allowed to form spontaneously at t=0 min. Afterwards, overhead stirring was used for 1 min to induce convection and maximize emulsion formation. The observed emulsion was then monitored over time at A) 0 min, B) 2 min, C) 203 min, D) 261 min, and E) 324 min. A noticeable emulsion was seen up to 261 min, showing stability over long periods of time.

FIG. 8 shows droplet size reproducibility measurements using DLS. DCE droplets were spontaneously formed in the aqueous phase when HAuCl₄ (2 mL, 10 mM) was pipetted above DCE (2 mL) containing [NBu₄][ClO₄] (0.1 M). All droplet DLS measurements were taken 5 minutes after contact of both solutions for an N=4.

FIG. 9 shows experimental controls for the effect of mutual saturation on the emulsification behavior. To test the effect of saturation on the system, mutually saturated solutions of water and DCE were tested for each phase. A water-saturated DCE phase was used as the organic phase, and a DCE-saturated water solution was used for the aqueous phase for both (A) and (B) images. Image (A) contained 10 mM HAuCl₄ with 1 M NaCl aqueous solution and 0.1 M [NBu₄][ClO₄] DCE solution, while Image (B) contained only NaCl and [NBu₄][ClO₄] (no HAuCl₄). The images shown were taken after 10 minutes of solutions being in contact.

FIG. 10 shows experimental control for the effect of NaCl vs. KCl on emulsification behavior. The DCE phase contained [NBu₄][ClO₄], and the aqueous phase contained HAuCl₄ and either 1 M KCl (A) or 1 M NaCl (B) for this experiment. An emulsion still formed at the liquid-liquid boundary, indicating that using NaCl vs. KCl in the aqueous phase has little effect on the spontaneous emulsification. These images were taken with a 40×NA 0.60 objective and a 500 ms exposure time.

FIG. 11 shows experimental control for the effect of NaCl on emulsification behavior. The DCE phase contained [NBu₄][ClO₄] (0.1 M), and the aqueous phase contained HAuCl₄ (10 m M), for this experiment. No additional supporting electrolyte was present in the aqueous phase (i.e., no sodium chloride). An emulsion still formed at the liquid-liquid boundary, indicating that neither Na⁺ nor Cl⁻ are necessary for spontaneous emulsification. This image was taken 10 minutes after the solutions were in contact. These images were taken with a 40×NA 0.60 objective and a 500 ms exposure time.

FIG. 12 shows the extent of emulsification as a function of transferring ion concentrations.

(A) Optical micrographs of the effect of HAuCl₄ concentration on droplet formation. An increase in concentration can be seen sequentially for I (0 mM), II (2.5 mM), III (5 mM), and IV (7.5 mM).

(B) Optical micrographs of the effect of [NBu₄][ClO₄] concentration on droplet formation. An increase in concentration can be seen sequentially for I (0 mM), II (10 mM), III (25 mM), and IV (50 mM).

(C) Optical micrograph for the droplet formation at 10 mM HAuCl₄ and 100 mM [NBu₄][ClO₄].

(D) Schematic representation of the proposed mechanism for partitioning of chloroaurate from aqueous to organic media in the presence of NBu₄⁺ while maintaining electroneutrality with ClO₄⁻ ion.

Histograms presented below the schematic representation show the effect of changes in concentration on the frequency (E) and (G) and average cross-sectional area (F) and (H) of droplets as a function of distance from the interface for chloroauric acid (E) and (F) and tetrabutylammonium perchlorate (G) and (H) respectively. The error bars in (F) and (H) correspond to standard deviations about the mean for N equal to the number of droplets identified in that region (from E and G). Data for histograms were gathered 10 minutes after initial contact of the aqueous and DCE phases. All optical micrographs were taken with a 40×NA 0.60 objective and a 500 ms exposure time.

FIG. 13 shows the effect of organic-phase electrolyte on emulsification behavior. (A) graphic showing initial conditions where the DCE phase contains 10 mM of a non-aqueous salt with variable cation (X) and anion (Y), while the aqueous phase contains 10 mM HAuCl₄ and 1M NaCl. (B)-(F) light microscope images showing the liquid-liquid interface after 10 min from initial contact of the two phases. All images show the DCE phase on the left and the aqueous phase on the right. For images (B)-(D), tetrabutylammonium (NBu₄⁺) salts were used in the DCE, with the anion being Br⁻ in image (B), ClO₄⁻ in image (C), or PF₆⁻ in image (D). For images (E) and (F), perchlorate salts were used in the DCE, with the cation being tetraethylammonium (NEt₄⁺, (E)) or tetrahexylammonium (NHx₄⁺, (F)). All optical micrographs were taken with a 40×NA 0.60 objective and a 500 ms exposure time.

FIG. 14 shows the determination of the effect of different ratios of [Cl]_{(aq)}:[ClO₄]_{(aq)} anions on emulsion behavior. The DCE phase contained [NBu₄][ClO₄] for all experiments. The aqueous phase contained HAuCl₄ with different ratios of sodium chloride and sodium perchlorate (but always 1M total supporting electrolyte concentration). The images were taken 10 minutes after the solutions were in contact.

FIG. 15 shows the degree of disequilibrium affects the extent of emulsification. (A) graphic showing initial conditions where the DCE phase contains 100 mM of tetrabutylammonium perchlorate, while the aqueous phase contains 10 mM HAuCl₄ with different ratios of sodium chloride and sodium perchlorate (but always 1M total supporting electrolyte concentration). Histograms show the number of emulsion droplets measured in (B) and the average area of measured droplets (C) as a function of distance from the liquid-liquid interface. All droplets were measured after 10 minutes from the initial time of contact. Ratios of [Cl⁻]_{(aq)}: [ClO₄⁻]_{(aq)} used were 0:100, 50:50, 80:20, 90:10, and 100:0. The error bars in (C) are standard deviations about the mean for N equal to the number of droplets identified in that region (from B).

FIG. 16 shows light microscopy images taken at the water-DCE boundary when the aqueous phase contained HAuCl₄ and the oil phase contained [NBu₄][ClO₄] for (A) dichloromethane, (B) nitrobenzene, and (C) chloroform with either (i) 1 M NaCl or (ii) 0 M NaCl present in the aqueous phase. The water and DCE phases are indicated, and the scale bars are 25 μm. All optical micrographs were taken with a 40×NA 0.60 objective and a 500 ms exposure time.

FIG. 17 shows emulsification achieved with different transferring ions, the effect of aqueous salt concentration, and the proposed microscopic model of flux-induced emulsification. Light microscopy images were taken at the water-DCE boundary when the aqueous phase contained (A) 10 mM HAuCl₄, (B) KSCN, or (C) K₃[Fe(CN)₆] with either (i) 1 M KCl or (ii) 0 M KCl. The DCE phase always contained 0.1 M [NBu₄][ClO₄]. The water and DCE phases are indicated, and the scale bars are 25 μm. (D) Proposed microscopic model of how the transferring ions can cause water-in-oil droplets and/or oil-in-water droplets to form and be stabilized by antagonistic salts. All optical micrographs were taken with a 40×NA 0.60 objective and a 500 ms exposure time.

FIG. 18 shows the graph for determining the partitioning coefficient of thiocyanate in water in the presence of [NBu₄][ClO₄] in DCE using UV-VIS spectroscopy. A 10 mM KSCN aqueous solution was allowed to partition for 2 hr in the presence of an equal volume of 0.1 M [NBu₄][ClO₄] in DCE. The resulting thiocyanate solutions were then exposed to an excess of Fe(NO₃)₃ to form a colored complex that was then measured with UV-VIS spectroscopy to identify the degree of partitioning. Solutions were diluted accordingly to meet the limitations of UV-VIS, and good linearity for all concentrations was observed. No noticeable variation was observed for the points within the curve shown; all points were measured for a minimum N=3.

FIG. 19 shows cyclic voltammetry for 10 mM potassium ferricyanide in 1 M KCl before and after contact with 0.1 M [NBu₄][ClO₄] DCE for partition coefficient measurements. The dashed gray trace corresponds to the concentration of the analyte of interest before mixing. The CV was taken from −0.1 V to 0.7 V vs. Ag|AgCl prior to mixing. The black trace corresponds to measurements in the aqueous phase after mixing. Measurements were made with a gold microelectrode (r=6.25 μm), a glassy carbon rod counter (r=0.5 mm), and a Ag|AgCl reference electrode at a 50 mV/s scan rate. The concentration was obtained by use of the difference in limiting current of both traces, where the partition coefficient was obtained to be Kp=0.03.

FIG. 20 shows the experimental setup for electro-emulsification in a two-phase system, which comprises the induction of ionic flux due to electrophoresis. A cathode and an anode were connected to platinum (Pt, r=1 mm) wires submerged in the aqueous (top) and oil (bottom) phases, respectively. Subsequent application of current to a two-phase system generated reactions in both phases and promoted the ionic flux of species across the liquid-liquid interface to maintain electroneutrality, as shown in panel B. This flux of species across the interface formed an emulsion over time, as shown in panel C.

FIG. 21 shows the glass cell images of DCE droplets formed in the aqueous phase before and after 5 mA current was applied to a two-phase system for about 5 min. A 3 mL aqueous top layer containing 0.1 M [NBu₄][Cl] was pipetted over 3 mL of DCE containing 0.1 M [NBu₄][PF₆], and a Pt wire (r=1 mm) was submerged in each phase to drive the current of 5 mA, with the cathode and anode placed in the aqueous phase and the organic phase, respectively.

FIG. 22 shows DLS measurements of DCE droplets formed in the aqueous phase when 5 mA current was applied to the two-phase system for about 5 min. (A) illustrates the measurements for the zeta potential and mean peak size. (B) illustrates timed stability measurements. DLS measurements were taken three times, for 60 runs at 1.64 s/run, with a 120 s equilibration time and an equilibration temperature of 25° C. A glass cuvette (1 cm) was used to hold solutions within the instrument.

FIG. 23 shows DLS measurements of aqueous droplets formed in an organic phase when 5 mA current was applied on a two-phase system for about 5 min using a Pt wire (r=1 mm). The data depicted correspond with cases shown in Table 3. A) The anode was placed in an aqueous phase containing 0.1 M [NBu₄][Cl], and the cathode was placed in an organic phase, such as DCE, containing 0.1 M [NBu₄][PF₆]. B) The cathode was placed in an aqueous phase containing 0.1 M [NBu₄][Cl], and the anode was placed in DCE containing 0.1 M [NBu₄][PF₆]. C) The cathode was placed in an aqueous phase containing no phase-transfer agent, and the anode was placed in DCE containing 0.1 M [NBu₄][PF₆]. D) The anode was placed in an aqueous phase containing no phase-transfer agent, and the cathode was placed in DCE containing 0.1 M [NBu₄][PF₆]. E) The cathode was placed in an aqueous phase containing 1 M NaOH, and the anode was placed in DCE containing 0.1 M [NBu₄][PF₆]. DLS measurements were taken three times, unless specified, for 60 runs at 1.64 s/run, with a 120 s equilibration time and an equilibration temperature of 25° C.

FIG. 24 shows DLS measurements of aqueous droplets formed in an organic phase when 5 mA current was applied on a two-phase system for about 5 min using a Pt wire (r=1 mm). The data depicted correspond with cases shown in Table 3. A) The anode was placed in an aqueous phase containing 1M NaOH, and the cathode was placed in DCE containing 0.1 M [NBu₄][PF₆]. B) The anode was placed in an aqueous phase containing 1M H₂SO₄, and the cathode was placed in DCE containing 0.1 M [NBu₄][PF₆]. C) The cathode was placed in an aqueous phase containing 1 M H₂SO₄, and the anode was placed in DCE containing 0.1 M [NBu₄][PF₆]. D) The cathode was placed in an aqueous phase containing no phase-transfer agent, and the anode was placed in DCE containing 0.1 M [NBu₄][TPB]. E) The cathode was placed in an aqueous phase containing no phase-transfer agent, and the anode was placed in DCE containing 0.1 M [NBu₄][Br]. F) The cathode was placed in an aqueous phase containing no phase-transfer agent, and the anode was placed in DCE containing 0.1 M [NHx][ClO₄]. DLS measurements were taken three times, unless specified, for 60 runs at 1.64 s/run, with a 120 s equilibration time and an equilibration temperature of 25° C.

FIG. 25 shows the DLS of aqueous droplets formed in various organic phases when 5 mA current was applied on a two-phase system for about 5 min using a Pt wire (r=1 mm). The data shown corresponds to two-phase electro-emulsification with variations in the organic solvent used. The cathode was placed in an aqueous phase containing no phase-transfer agent, and the anode was placed in an organic phase containing 0.1 M [NBu₄][PF₆]. The organic solvents used were 1,2-dichloroethane (A, B respectively), chloroform (C, D respectively), and methylene chloride (E, F respectively). DLS measurements were taken three times, unless specified, for 60 runs at 1.64 s/run, with a 120 s equilibration time and an equilibration temperature of 25° C.

### DETAILED DESCRIPTION

While the concepts of the present disclosure are illustrated and described in detail in the figures and the description herein, results in the figures and their description are to be considered as exemplary and not restrictive in character; it being understood that only the illustrative embodiments are shown and described and that all changes and modifications that come within the spirit of the disclosure are desired to be protected.

As used herein, the following terms and phrases shall have the meanings set forth below. Unless defined otherwise, all technical and scientific terms used herein have the same meaning as commonly understood to one of ordinary skill in the art.

The term “ionic flux” refers to the transfer of ions across a liquid-liquid boundary or the rate of ions moving across a liquid-liquid boundary per unit area of the interface between the two liquid phases.

The terms “flux”, “ionic flux”, and “anion flux” are used interchangeably.

The term “partitioning agent” refers to a compound comprising a cation and an anion wherein the anion serves as a partitioning anion to produce the ionic flux across a liquid-liquid boundary leading to the formation of emulsion.

Provided is a method for spontaneous emulsification. The method comprises:
mixing (i) an aqueous phase comprising a partitioning agent, which contains a partitioning anion, which determines the hydrophilicity of the partitioning agent, alone or in further combination with an electrolyte, with (ii) an oil phase comprising a phase-transfer agent, wherein the phase-transfer agent creates and promotes an interfacial flux of an anion and promotes formation of droplets at a liquid-liquid interface of the aqueous phase and oil phase, whereupon the emulsification is spontaneously formed.

The spontaneous emulsification at a liquid-liquid interface can be achieved using a phase transfer agent in an oil phase and a partitioning agent in an aqueous phase. The method comprises mixing the oil phase with the aqueous phase, wherein the aqueous phase comprises the partitioning agent, which contains a partitioning anion, alone or further in combination with an electrolyte, and the oil phase comprises the phase-transfer agent. The phase-transfer agent induces significant anion flux between the oil phase and the aqueous phase and promotes the formation of droplets at the liquid-liquid interface. This emulsification method does not require any external energy and the use of larger amounts of amphiphilic solvents or additional organic solutes.

The phase-transfer agent used can be any suitable phase-transfer agent. In some embodiments, the phase-transfer agent is a quaternary ammonium salt. Examples of quaternary ammonium salts include, but are not limited to, tetralkylammonium salts such as tetrabutylammonium perchlorate[NBu₄][ClO₄], tetrabutylammonium hexafluorophosphate [NBu₄][PF₆], tetrabutylammonium bromide[NBu₄][Br], tetrabutylammonium chloride[NBu₄][Cl], tetraethylammonium perchlorate[NEt₄][ClO₄], tetrabutylammonium tetraphenylborate ([NBu₄][TPB]), and tetrahexylammonium perchlorate[NHx₄][ClO₄].

In exemplary embodiments, the phase-transfer agent is [NBu₄][ClO₄]. The concentration of [NBu₄][ClO₄] that can be used ranges from about 10 mM to about 100 mM, (e.g., about 10 mM to 100 mM, 10 mM to about 100 mM, or 10 mM to 100 mM).

The oil phase can be any suitable oil phase. In some embodiments, the oil phase can be an organic solvent. Examples of organic solvents include, but are not limited to, dichloroethane (DCE), dichloromethane, chloroform, and nitrobenzene.

The partitioning agent used in an aqueous phase can be selected from chloroauric acid (HAuCl₄) containing AuCl₄⁻ partitioning anion, potassium thiocyanate (KSCN) containing SCN⁻ partitioning anion, and potassium ferricyanide (K₃[Fe(CN)₆]) containing Fe(CN)₆³⁻ partitioning anion. In some embodiments, the partitioning agent is HAuCl₄. The concentration of the partitioning agent in aqueous phase can range from about 1 mM to about 10 mM (such as from about 1 mM to 10 mM, 1 mM to about 10 mM, or 1 mM to 10 mM).

The electrolytes can be any suitable electrolytes. In some embodiment, the electrolytes can be salts selected from inorganic halides such as potassium chloride, sodium chloride, calcium chloride, ammonium chloride, potassium iodide, sodium iodide, and sodium perchlorate. The amount of the electrolyte that can be used ranges from 0 M to 1 M.

In some embodiments, the partitioning agent is HAuCl₄, the oil phase is DCE, and the phase transfer agent is [NBu₄][ClO₄].

In some embodiments, a high degree of anion flux and formation of droplets at a liquid-liquid interface can be achieved, for example, by mixing an aqueous phase comprising HAuCl₄ with the DCE phase comprising [NBu₄][ClO₄]. The emulsion droplets, both water-in-oil and oil-in-water, can be observed at the interface when AuCl₄⁺ partitioning anion interacts with NBu₄⁺ cation and transfers into the oil phase, while ClO₄⁻ anion transfers into the aqueous phase to maintain electroneutrality. The NBu₄⁺ cation can facilitate the transfer of anions across the two phases. The sufficient anion flux across the interface can thus induce emulsification at the liquid-liquid boundary.

As shown in FIG. 4, when the DCE comprising [NBu₄][ClO₄] and the aqueous phase comprising HAuCl₄ and NaCl come into contact, DCE droplets begin to form in the aqueous phase as early as in about ten seconds. There was no emulsion formation in the absence of HAuCl₄ or

The DCE droplets can grow over time via coalescence. The coalescence can occur both between neighboring droplets and between emulsion droplets and the bulk DCE phase. DCE droplets in the aqueous phase can sometimes coalesce with the bulk DCE phase. The formed droplets can be stable for over an hour as compared to the existing ultrasonic process, and the diameter of the droplets can decrease from just over 1 μm to less than 1 μm within the hour. The droplet sizes can be reproducible if emulsions are prepared under the same conditions. The average droplet diameter is 1390 nm, with a relative standard deviation (RSD) of 12.3%.

The degree of emulsification can be controlled by adjusting a) either the hydrophilicity, the concentration, or both the hydrophilicity and concentration of the partitioning agent in the aqueous phase; or b) adjusting either the hydrophilicity, the concentration, or both the hydrophilicity and concentration of the phase-transfer agent in the oil phase.

The factors that affect emulsification can be:
i) The presence of both phase-transfer agent and partition agent. The spontaneous emulsification cannot be obtained due to the dissolution of water into DCE and vice versa. Also, the degree of saturation of the aqueous and DCE phases prior to mixing does not play a critical role in emulsion formation. For example, when a water-saturated DCE phase comprising [NBu₄][ClO₄] was mixed with a DCE-saturated aqueous phase comprising only NaCl without using HAuCl₄, no emulsification was observed. It was only when HAuCl₄ was also present in the DCE-saturated aqueous solution that emulsification spontaneously occurred. Thus, both the phase-transfer agent, such as [NBu₄][ClO₄], and the partitioning agent, such as HAuCl₄, are necessary to achieve spontaneous emulsification.
ii) The absence of electrolytes such as NaCl or KCl entirely from the aqueous phase can cause emulsification on both sides of the liquid-liquid interface, with water droplets forming in DCE and DCE droplets forming in water (see FIG. 11).
iii) The concentration of partitioning agent or phase-transfer agent: No detectable emulsion can occur when either the partitioning agent, such as HAuCl₄, or the phase-transfer agent, such as [NBu₄][ClO₄], is not present in the aqueous or DCE phases respectively. The degree of emulsification can increase proportionally as the concentration of HAuCl₄ or [NBu₄][ClO₄] increases (FIG. 12). The highest degrees of emulsification can be obtained at higher concentrations of both HAuCl₄ and [NBu₄][ClO₄] (see, FIG. 12C, FIG. 12E, and FIG. 12G). The average cross-sectional area of droplets can be the largest under the conditions of the highest concentrations of HAuCl₄ or [NBu₄][ClO₄]. Thus, the concentration dependence on emulsification signifies that ionic flux plays a critical role in emulsification.

FIG. 12 shows that the degree of emulsification can directly be related to the concentrations of the partitioning agent, such as HAuCl₄, and the phase-transfer agent, such as [NBu₄][ClO₄], and thus can be controlled by adjusting the concentration of HAuCl₄ in aqueous phase or by adjusting the concentration of [NBu₄][ClO₄] in DCE phase. The degree of AuCl₄⁻ partitioning anion controls the degree at which an emulsion forms. When AuCl₄⁻ anion partitions, it accompanies an anion transferring from the DCE phase to the aqueous phase, (e.g., perchlorate anion transfers into the aqueous phase) to maintain electroneutrality. Thus, the mechanism for emulsification can be explained by the reaction shown in FIG. 12D and represented by the forward reaction of the following equilibrium equation:

$${AuCl}_{4}^{-} ( aq ) + {ClO}_{4}^{-} ( DCE ) ⇌ AuC {l}_{4}^{-} ( DCE ) + {ClO}_{4}^{-} ( aq )$$

It is well known that phase-transfer agents, such as quaternary ammonium salts and phosphonium salts, have an innate ability to transfer reactants between immiscible phases to promote reactions that would normally be difficult (Starks, C. M. et al., Phase-Transfer Catalysis: Fundamentals, Applications, and Industrial Perspectives; Springer, 1994). The phase-transfer agent, such as [NBu₄][ClO₄], can facilitate reactions by promoting changes in solubility and activating a reactant prior to reaction. NBu₄⁺ facilitates the partitioning of AuCl₄⁻ and can drastically increase the flux of an AuCl₄⁻ anion.

The spontaneous emulsification can also be driven by the partitioning of ions at the boundary and the flux of ions to the boundary. When ions transfer across the liquid-liquid interface, complex ions form that can stabilize curved interfaces. Such ions are called antagonistic salts. The antagonistic salt plays a key role in stabilizing the formed droplets in either phase. For example, AuCl₄⁻ and [NBu₄+] ions, when transferred across the liquid-liquid interface, form tetrabutylammonium chloroaurate complex ions. In a complex matrix, molecules that have the highest affinity for the boundary can adsorb to the boundary. Thus, the same antagonistic salt can stabilize the droplets formed in either phase. The droplet formation depends on the ability and orientation of complex ions (antagonistic salts) at the boundary to stabilize droplets in one phase over another.

In addition to the antagonistic salts, the formation of droplets also depends on hydrophilicity/hydrophobicity and hardness/softness of the transferring ions and solvation competition with other ions in the solution.

The degree of emulsification that is based on the hydrophilicity or hydrophobicity of ions was tested using different salts. For example, the phase-transfer agent with tetrabutyl ammonium salt (NBu₄⁺) and anions such as Br⁻, ClO4⁻, or PF6⁻ were used in the oil phase. FIG. 13A shows the various cations and anions that can be changed. Changing the anion that transfers into the aqueous phase (FIG. 13B and FIG. 13D) to maintain electroneutrality had a significant effect compared to the control (FIG. 13C). The more hydrophilic the anion, the more rapidly the droplets formed. A more hydrophobic anion, such as PF₆⁻, has a less favorable free energy change upon transferring from DCE to water (see Table 1), which disfavors the flux of ions and prevents emulsion formation. For tetraethylammonium salts (NEt₄⁺), with ClO₄ anion there was no droplet formation since the tetraethylammonium perchlorate salt did not allow droplet formation because the salt is soluble in water. Droplets did not form in the presence of tetrahexylammonium perchlorate as well because of the hydrophobicity of the alkylammonium salt. Large carbon chains may be drawn to organic solvents but do not provide the necessary activation for reaction.

TABLE 1
Gibbs free energy of ion transfer and the ion transfer potentials
for relevant ions across the water and DCE phase

| Ion: | ΔG_{w→DCE}⁰ (kJ/mol) | Δφ_{w→DCE}⁰ (mV) |
|---|---|---|
| H⁺ | 60.5 | −627 |
| Na⁺ | 58.9 | −610 |
| K⁺ | 52.9 | −548 |
| NEt₄⁺ | 4.2 | −44 |
| NBu₄⁺ | −21.8 | 226 |
| Cl⁻ | 46.4 | −481 |
| ClO₄⁻ | 17.2 | −178 |
| Br⁻ | 38.5 | −399 |
| PF₆⁻ | 8.7 | −90 |

(ΔG_{w→DCE}⁰ are reported values)

The transfer of water droplets in the oil phase or oil droplets in the water phase can be controlled by adding or removing an additional electrolyte in the water phase. As shown in FIG. 10 and FIG. 11, the presence of an aqueous electrolyte NaCl or KCl can influence water droplet formation in the DCE phase but does not affect the DCE droplet formation in the aqueous phase. This happens due to the solvation of the transferring aqueous anions and cations transferring across liquid-liquid boundaries bringing solvent molecules with them (FIG. 17A-FIG. 17 C). For example, when KCl is present in the water, the AuCl₄⁻ can become less solvated in the aqueous phase, and they can transfer with less solvent molecules because of solvation competition with other ions. When KCl is absent in the aqueous phase, more water molecules can transfer with the anions so that water droplets can form in the DCE. The same results can be seen with other aqueous anions, e.g., SCN⁻ and [Fe(CN)₆]³⁻. This is because DCE droplets can be stabilized in some cases by an antagonistic salt, as is the case when using a partitioning agent.

In the case of partitioning agent K₃[Fe(CN)₆], the Fe(CN)₆³⁻ is the example of most hydrophilic ions where one can observe anion flux-induced emulsification. An important aspect of spontaneous emulsification is the solvation about the transferring ions. Ferricyanide ions are much more hydrated and can increase the probability of water droplet formation.

Ions that transfer from the water to the oil phase can bring water molecules with them, forming a finger-like structure, whereas the ions that transfer from the oil phase into water do not bring in solvent molecules and instead can get facilitated by water fingers that can engulf oil-phase ions (Benjamin, 1. Mechanism and Dynamics of Ion Transfer Across a Liquid-Liquid Interface. Science, 1993, 261 (5128), 1558-1560). The substantial ion transfer can create morphologies due to many water fingers (FIG. 17D). Protrusions of water fingers can pinch off upon further ionic flux in all cases. However, in cases where there is a sufficiently high degree of ionic flux, the density of water fingers is high enough such that water can enclose regions of oil to form oil droplets. This is why AuCl₄⁻, which strongly partitions into the DCE phase, created DCE droplets in water (FIG. 17A), whereas other ions with lower partition coefficients, like SCN⁻ and Fe(CN)₆³⁻, cannot form dense enough regions of water fingers to enclose oil droplets and instead only produce water droplets (FIG. 17B and FIG. 17C). The partition coefficient of SCN⁻ from water to DCE using the colorimetric experiment can be about 0.07 (FIG. 18) and the partition coefficient of Fe(CN)₆³⁻ using voltammetric experiment can be 0.03 (FIG. 19). These partition coefficients are orders of magnitude smaller than the corresponding partition coefficient for AuCl₄⁻, which explains the lack of DCE droplets formed in these cases.

The droplets can form both in the aqueous and oil phase, but the stability of those droplets depend strongly on how well the antagonistic salt stabilizes a droplet in a given phase. With partitioning agents KSCN and K₃[Fe(CN)₆], the antagonistic salt formed is tetrabutylammonium thiocyanate, which is not an effective stabilizer of DCE droplets in water, thus no DCE droplets formed in the aqueous phase. Furthermore, Fe(CN)₆³⁻ is the most hydrophilic anion, where one can observe anion flux-induced emulsification. Thus, another important aspect of the method of the present disclosure is the solvation about the transferring ions. Ferricyanide will be much more hydrated, which can increase the formation of water droplet.

Overall, the present disclosure provides a method for emulsification without the use of large amounts of amphiphilic solvents or additional organic solutes. This method uses a phase-transfer agent to create and promote the flux of an anion, such as AuCl₄⁻, and the degree of emulsification can be tuned by the hydrophilicity and/or concentration of a secondary anion in the DCE solution.

In some embodiments, similar to chemical potential gradients across liquid-liquid boundaries that can create an ionic flux of anions across the interface, an electrical potential can also be used to generate sufficient ionic flux by creating an electrical potential difference across the interface and to achieve flux-induced emulsification in the presence of ionic species. This spontaneous electro-emulsification process requires low energy and can be achieved by creating ionic flux without using complex phase-transfer agents. Ionic flux across a liquid-liquid interface can be created by applying a difference in electric potential across the interface in the presence of ionic species (auto-dissociation provides ions even in pure water) and one or more electrodes, such as an anode and a cathode, connected to a conductive metal wire in each phase. This spontaneous fluxification of an interface can induce emulsification if the flux is high enough.

The application of constant current can drive reactions in each phase and can transfer ions across the water-oil interface to maintain electroneutrality, which leads to fluxification (flux-induced emulsification). The formation of an emulsion can be observed at or near the liquid-liquid interface. Thus, the solute flux through an interface is responsible for the spontaneous emulsification.

Provided is a method for spontaneous electro-emulsification. The method comprises:
a. mixing (i) an aqueous phase, optionally comprising a phase-transfer agent, with (ii) an oil phase comprising at least one phase-transfer agent, wherein the aqueous phase and the oil phase each comprises an electrode connected to a conductive metal wire; and
b. applying a voltage,
wherein a voltage difference is created, which promotes an interfacial flux of an anion and promotes formation of droplets at a liquid-liquid interface of the aqueous phase and oil phase, whereupon the spontaneous electro-emulsification is formed.

Emulsification can occur by applying a current of at least about 2 mA/cm². In some embodiments, the current is 2 mA/cm². In some embodiments, the current is 3 mA/cm². In some embodiments, the current is 5 mA/cm². The voltage applied is about 30 V. The spontaneous emulsification can be achieved in both phases by selecting the ions and exposing both phases to anodic-cathodic currents. In some embodiments, the electrode can be a cathode or an anode. Any suitable conductive metal wire can be used. In some embodiments, the metal wire is platinum (Pt), steel, graphite, aluminium, or copper wire. In some embodiments, the metal wire is Pt wire.

The phase-transfer agent used for electro-emulsification can be any suitable phase-transfer agent. In some embodiments, the phase-transfer agent is a quaternary ammonium salt. Examples of quaternary ammonium salts include, but are not limited to, tetralkylammonium salts such as tetrabutylammonium tetrabutylammonium perchlorate[NBu₄][ClO₄], hexafluorophosphate [NBu₄][PF₆], tetrabutylammonium bromide[NBu₄][Br], tetrabutylammonium chloride[NBu₄][Cl], tetraethylammonium perchlorate [NEt₄][ClO₄], tetrabutylammonium tetraphenylborate ([NBu₄][TPB]), and tetrahexylammonium perchlorate[NHx₄][ClO₄].

The emulsification can be stable for over an hour, even without using surfactant. The droplet size and charge can be controlled based on phase-transfer agent, applied currents, and polarity of the interface. The oil emulsions in water and water emulsions in oil can be made by tuning the ions in the respective phases, applying the voltage and current to drive ion transfer, and the polarity of the voltage application.

The positioning of the cathode and anode in two phases affects the droplet sizes. For example, the average droplet size when the cathode was placed in the aqueous layer was about 1209 nm and about 568 nm when placed in the oil phase. The average size of droplets and zeta potential can increase with increased hydrophilicity of anion (see Table 3). The electro-emulsion achieved by ionic flux is energy efficient and requires low energy. In some embodiments, the energy required has a lower bound of about 1 watt as compared to hundreds of watts required by the methods well known in the art. In some embodiments, the energy required for electro-emulsification is about 0.1 watt. In some embodiments, the energy required is 0.09 watt.

### EXPERIMENTAL

The following examples serve to illustrate the present disclosure. The examples are not intended to limit the scope of the claimed invention in any way.

### Materials:

All reagents used for the process shown here were of analytical grade and were used without further purification. All solutions were prepared with fresh solvents, aqueous solutions were prepared with ultra-pure water (18.20 MΩ·cm) obtained from a Millipore GenPure water filtering system.

Organic solutions were prepared with 1,2-dichloroethane (DCE), dichloromethane, chloroform, or nitrobenzene obtained from Sigma-Aldrich. Organic salts such as tetrabutylammonium perchlorate (99% purity), tetrabutylammonium hexafluorophosphate (99% purity), tetrabutylammonium bromide (97% purity), tetrabutylammonium chloride (99% purity), tetraethylammonium perchlorate (97% purity) and tetrahexylammonium perchlorate (97% purity) were obtained through Sigma-Aldrich. Potassium thiocyanate and potassium hexacyanoferrate (III) were obtained from Thermo Scientific, whereas iron (III) nitrate was obtained from Aldrich. Sodium chloride (99% purity) from Fisher Bioreagents and sodium perchlorate (98% purity) obtained through Sigma-Aldrich were used for aqueous solutions. Solutions containing gold were based on chloroauric acid (99.995% purity) obtained through Sigma-Aldrich.

New glass coverslips were used for each experiment prior to each test and were obtained from VWR (Radnor, PA). A 24×40 mm cover glass was used on the bottom, and a 25×25 mm cover glass was used on top. A gold ultramicroelectrode (r=6.25 μm) and Ag-AgCl reference electrode were obtained from CH Instruments (Austin, TX). Dynamic light scattering (DLS) measurements of droplet sizes were performed using a Zetasizer Ultra instrument (Malvern Panalytical, Worcestire, UK). Orion, Versa Star Pro benchtop meter, and Thermo Scientific over head stirrer were used.

### Methods:

The Gibbs free energy of ion transfer and the ion transfer potentials for relevant ions across the water and DCE phase were studied. Table 1 shows the standard Gibbs free energy of ion transfer from water (w) to DCE, as reported in Analytical Chemistry, 2010, 82 (18), 7857-7860; Electrochimica Acta 1989, 34(2), 93-107 and the standard ion transfer potentials of HAuCl₄ and [NBu₄][ClO₄] ions from water to DCE.

TABLE 1

| Ion: | ΔG_{w→DCE}⁰ (kJ/mol) | Δφ_{w→DCE}⁰ (mV) |
|---|---|---|
| H⁺ | 60.5 | −627 |
| Na⁺ | 58.9 | −610 |
| K⁺ | 52.9 | −548 |
| NEt₄⁺ | 4.2 | −44 |
| NBu₄⁺ | −21.8 | 226 |
| Cl⁻ | 46.4 | −481 |
| ClO₄⁻ | 17.2 | −178 |
| Br⁻ | 38.5 | −399 |
| PF₆⁻ | 8.7 | −90 |

(ΔG_{w→DCE}⁰ are reported values)

### Microscopy Experiments

All microscopy experiments were performed on glass slides, onto which a pentagon of droplets of an aqueous solution containing HAuCl₄, with or without NaCl were pipetted onto the surface of the glass slide. Droplets of DCE solution containing [NBu₄][ClO₄] was then pipetted onto the center of the pentagon of aqueous droplets. This allowed for the aqueous phase to surround the DCE phase and maximize contact area, while minimizing effects caused by evaporation. A cover slide was then placed on top of all droplets, making sure that solutions did not spread outside of the covered area. Finally, optical images were taken in transmission mode at timed intervals to allow for qualitative and quantitative assessment of microdroplet formation. This process was repeated for variations of concentrations of HAuCl₄,

The experiments were performed for different sources of partitioning agents such as KSCN or K₃[Fe(CN)₆]; for different ionic strengths of aqueous solution with or without electrolytes either NaCl or KCl; different oil phases such as dichloromethane, chloroform, and nitrobenzene; and for various phase-transfer agents such as tetrabutylammonium hexafluorophosphate, tetrabutylammonium bromide, tetrabutylammonium chloride, tetraethylammonium perchlorate, and tetrahexylammonium perchlorate.

All optical micrographs were taken with a Leica DMi8 inverted microscope obtained from Leica Microsystems (Germany). A TL LED Lamp 12V DC max light source was used to illuminate glass slides in a transmission microscopy mode and was also obtained from Leica Microsystems. Images were taken with the use of a C15440 OrcaFusionBT sCMOS camera obtained from Hamamatsu Photonics (Japan). A 40× objective with NA of 0.60 was obtained from Leica Microsystems and was used for all micrographs. Images and optical videos were recorded in bright-field illumination with an exposure time of 500 ms.

### Droplet Size Measurements

An aqueous HAuCl₄ solution was pipetted into an equal volume of DCE solution containing [NBu₄][ClO₄] (0.1 M) in a scintillation vial. An overhead stirrer was used to induce convection in the aqueous phase for 1 minute. Droplets were allowed to form for five or ten minutes, and then portions of the aqueous solution containing DCE droplets were pipetted from the scintillation vial to a 1 cm glass cuvette, which was inserted into the DLS instrument. The DLS measurement was taken for 60 runs at 1.64 s/run with 120 s equilibration time at an equilibration temperature of 25° C. The polydispersity index was below 0.1 for these measurements.

### Droplet Measurements

Droplet measurements were conducted using ImageJ's image analysis software. Images for the emulsion formation at the interface were opened and analyzed with the region of interest (ROI) manager tool. The scale bar and pixel vs. distance scale was set prior to measurements by calibrating the internal scale to the scale bar provided within each image by the microscope software. Each droplet was then individually added as a site of interest, with its shape approximated to the nearest ellipse. The area and centroid position were then recorded for each individual drop after all ROI's were identified using the measure tool. Additionally, the centroid position of individual points (approximately 1 μm apart) along the liquid-liquid interface was measured. After measurement, all data was exported, and droplets were sorted according to their size and distance to the interface. The centroid position of each droplet was obtained within ImageJ, and then the closest distance from the center of each droplet to the interface was calculated by use of the Pythagorean theorem for all possible points. Finally, the shortest calculated hypotenuse was used as the reported distance to the interface.

### Partition Coefficient Studies

The partition coefficient of SCN⁻ and [Fe(CN)₆]³⁻ ions were measured using UV-VIS, and electrochemical methods, respectively. In both experiments, an equal volume of either potassium thiocyanate (10 mM) or potassium ferricyanide (10 mM) was added to a scintillation vial containing an equal volume of a DCE solution containing [NBu₄][ClO₄] (0.1 M) solution. These two phases were then vigorously mixed for 5 min to maximize partitioning between the two phases. Each vial was then set aside for about 2 hr to allow the solutions to reach equilibrium and allow phase separation due to differences in density. For the thiocyanate experiment, a V-650 UV-VIS spectrophotometer (Jasco Inc., Japan) was used. The aqueous phase was removed from the vial, and an excess of Fe(NO₃)₃ was added to form a red complex with the remaining thiocyanate that did not partition. The same was done for the 10 mM potassium thiocyanate solution used before contact with the organic solution. Absorbance measurements were made on these complexation solutions before and after partitioning.

Additionally, absorbance measurements were made on stock solutions of known thiocyanate solutions with excess Fe(NO₃)₃ to create a calibration plot. The absorbance value of the potassium thiocyanate solutions before and after partitioning was then used to find the initial and final concentrations of thiocyanate. The ratio of these concentrations was then used to calculate the partition coefficient. The experiment was repeated for an N=4.

Thiocyanate concentrations and partitioning coefficients were determined by the use of UV-VIS spectrometry. Both known and unknown concentrations of thiocyanate were then complexed with the known concentration of Fe(NO₃)₃. The colored complex was then measured with UV-VIS spectroscopy to identify the degree of partitioning using a calibration curve. The difference in concentration prior to and post-partitioning was then used to identify its partitioning coefficient. For the identification of the partitioning coefficient of ferricyanide, the concentration of ferricyanide in the aqueous phase was measured prior to and post-partitioning. This was measured by use of cyclic voltammetry with a r=6.25 μm microelectrode (see FIG. 19).

### Results:

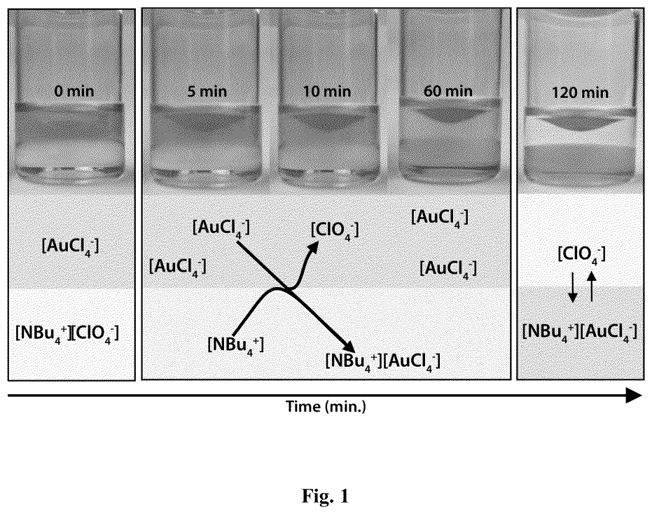

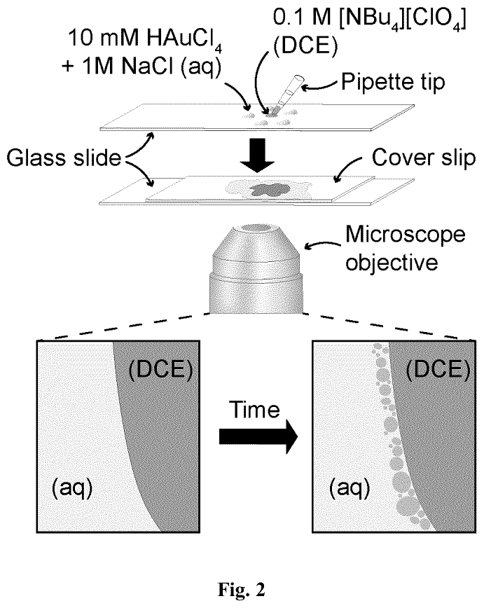

Liquid-liquid interfaces were created when a DCE phase containing [NBu₄][ClO₄] (0.1 M) was mixed with an equal volume of an aqueous solution of HAuCl₄ (10 mM) and NaCl (1 M) (see FIG. 1). When both HAuCl₄ and [NBu₄][ClO₄] were present, the bulk anionic transfer of chloroaurate from the water to the oil phase necessitates perchlorate ion crossing the DCE phase boundary to maintain electroneutrality.

DCE droplets started forming in the aqueous phase as early as 10 s after the two phases were mixed. An emulsion began forming at the liquid-liquid interface, observed with transmission light microscopy. No emulsion was observed if either HAuCl₄ or [NBu₄][ClO₄] were not present.

These DCE droplets appeared to grow over time, often via coalescence, where two DCE droplets fused to form a larger droplet. Occasionally, DCE droplets in the aqueous phase coalesced with the bulk DCE phase over time, a greater number of droplets formed and do so further away from the liquid-liquid boundary. The number of droplets within 10 μm of the interface decreased with time due to coalescence (FIG. 15). This coalescence can occur both between neighboring droplets and between emulsion droplets and the bulk DCE phase. This coalescence was visually observed and substantiated by the corresponding increase in the average cross-sectional area of droplets within this range. At all-time points, the average droplet area decayed with decreasing distance from the interface.

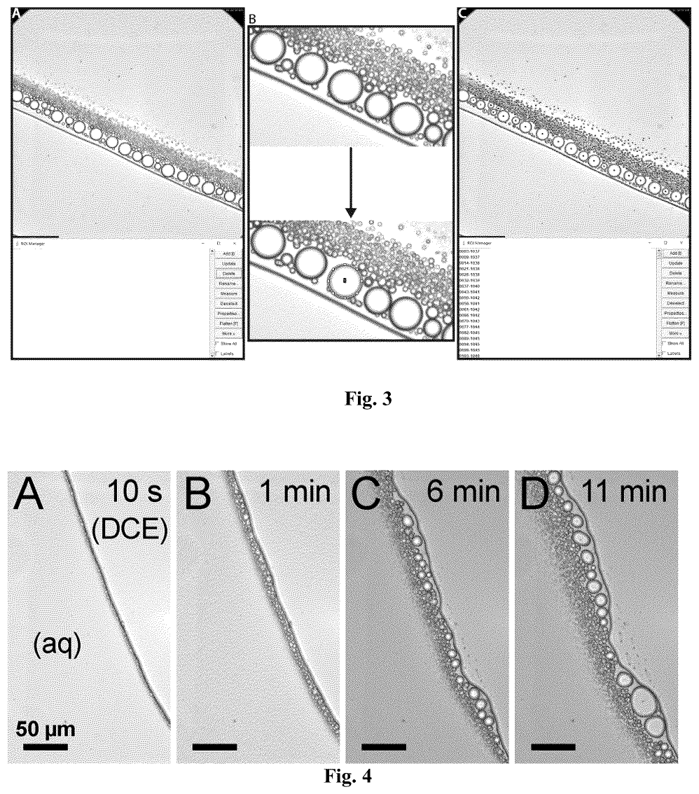

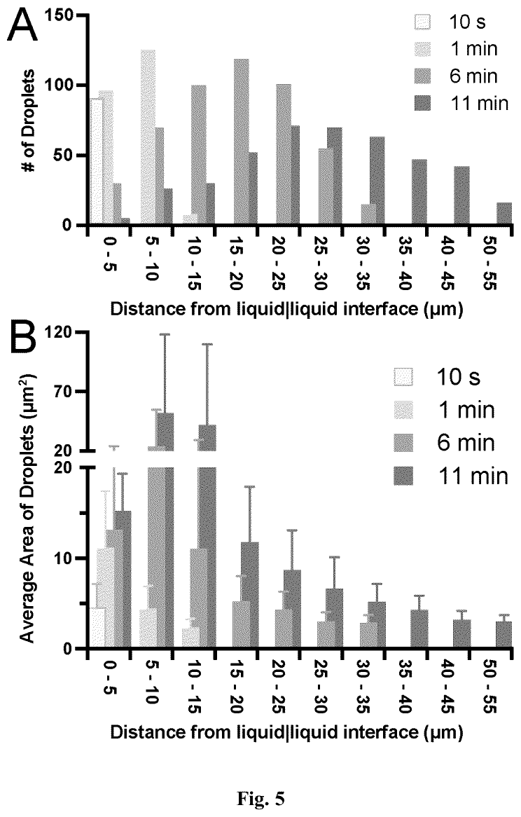

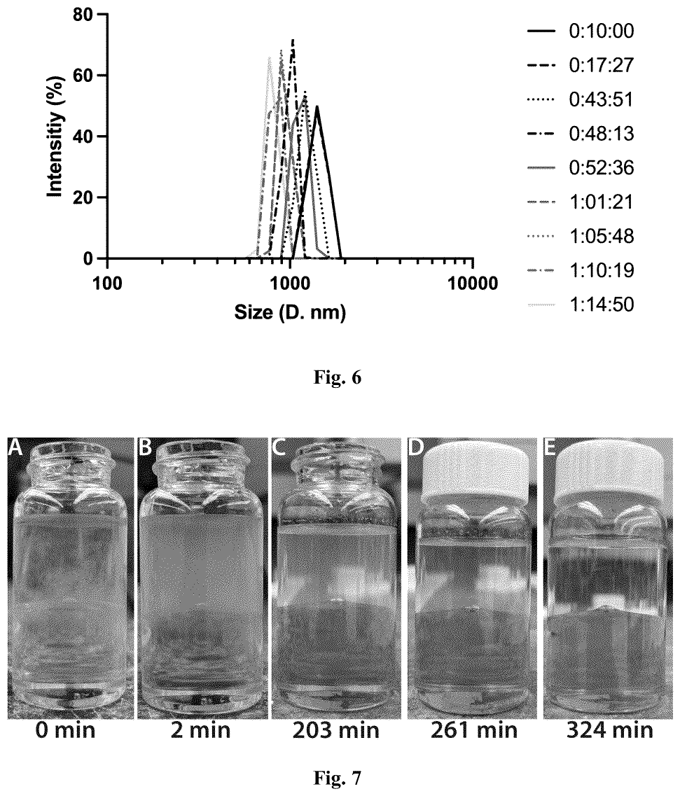

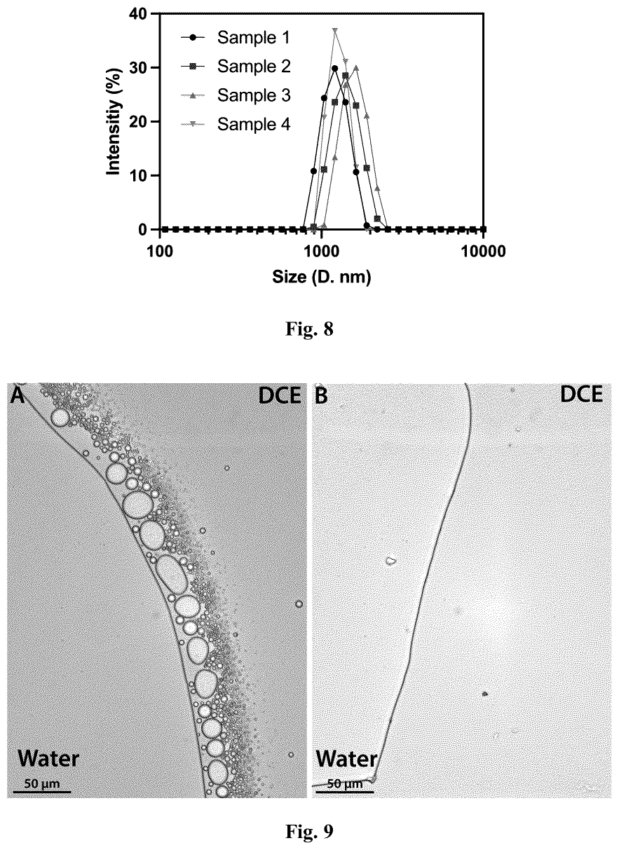

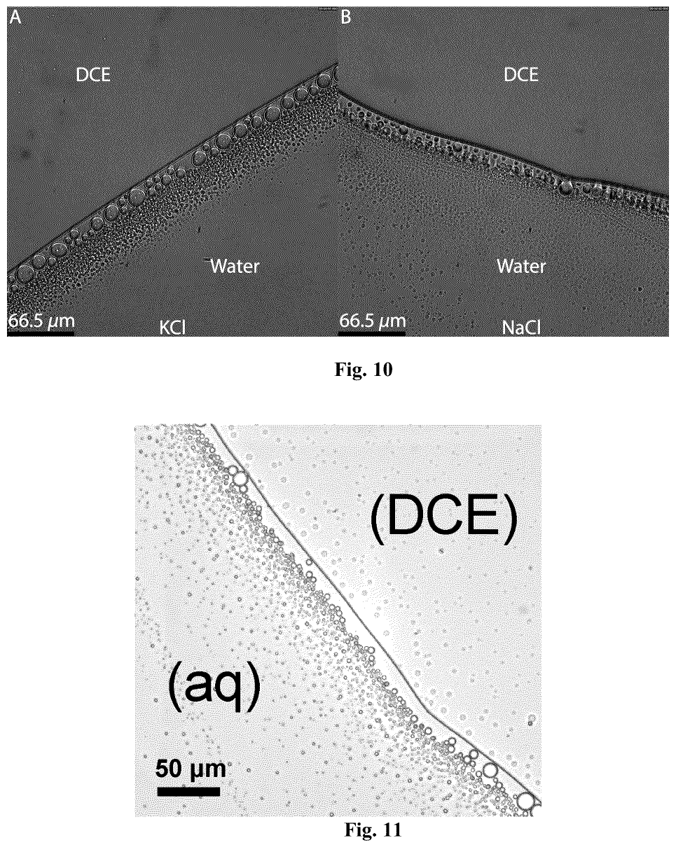

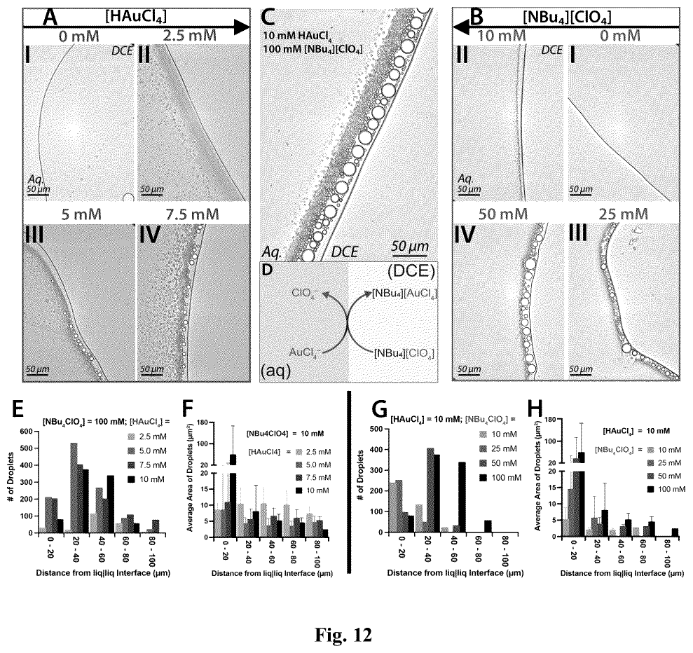

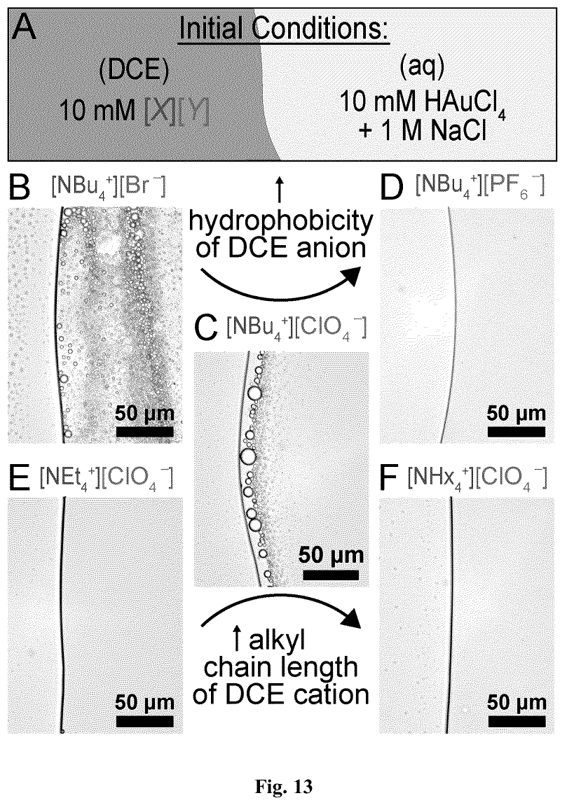

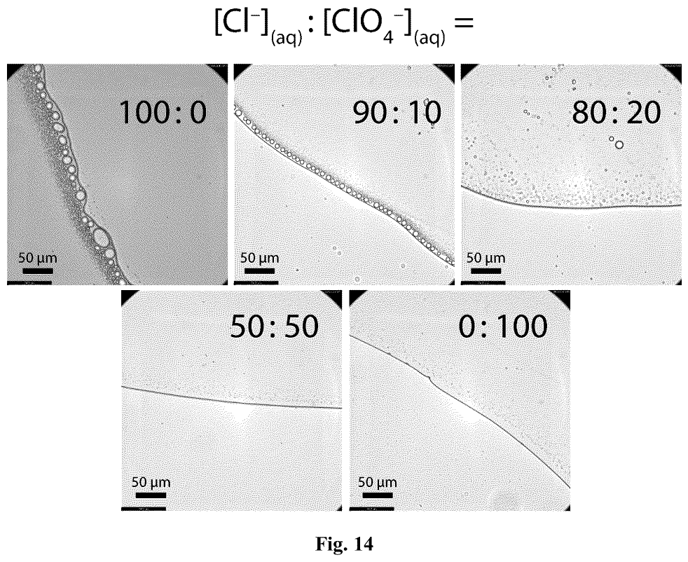

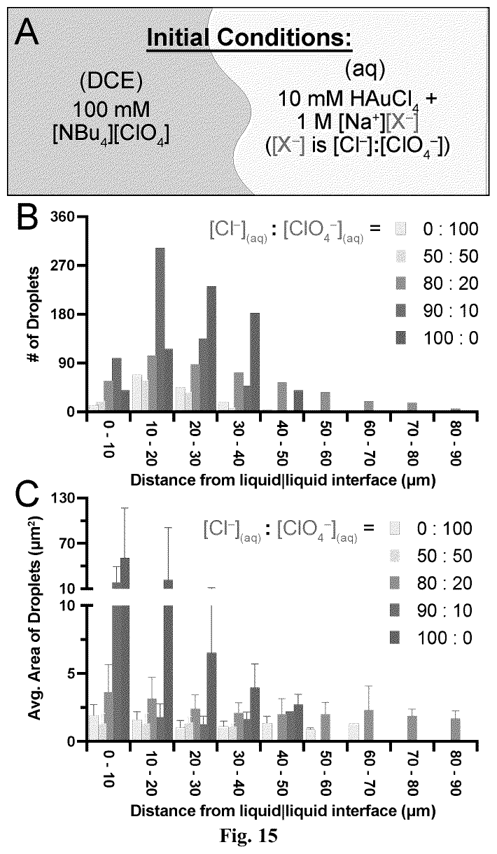

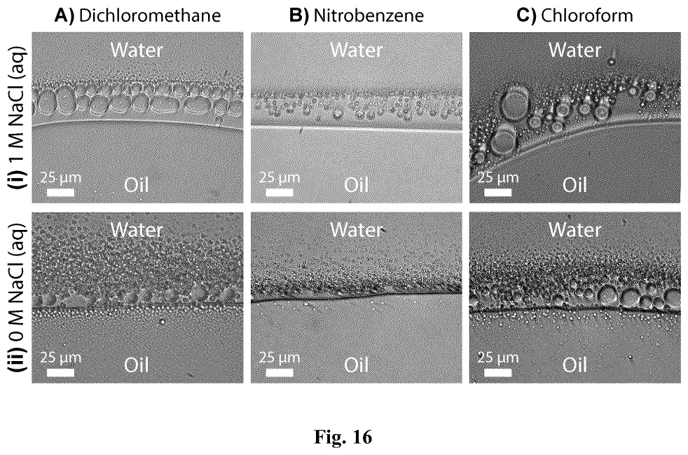

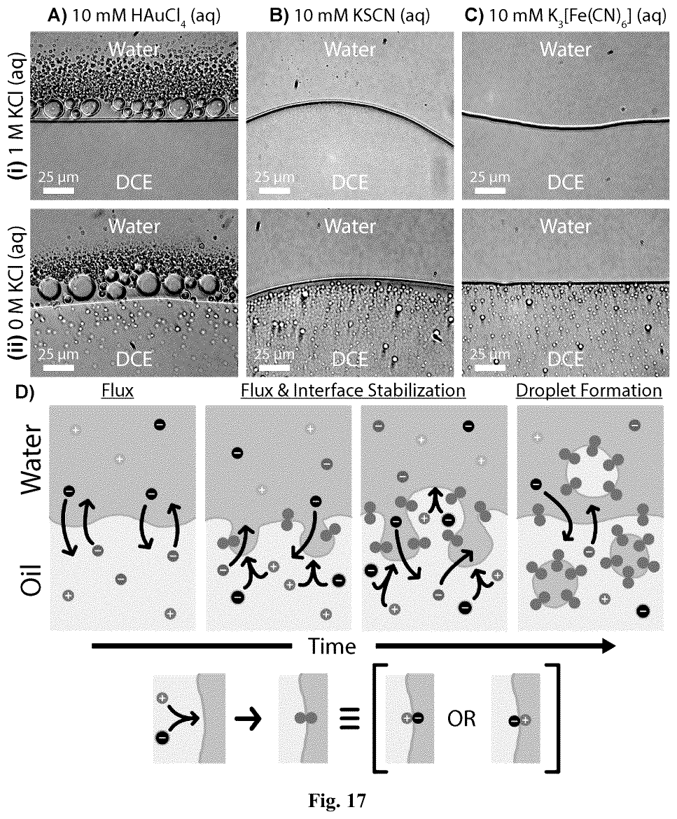

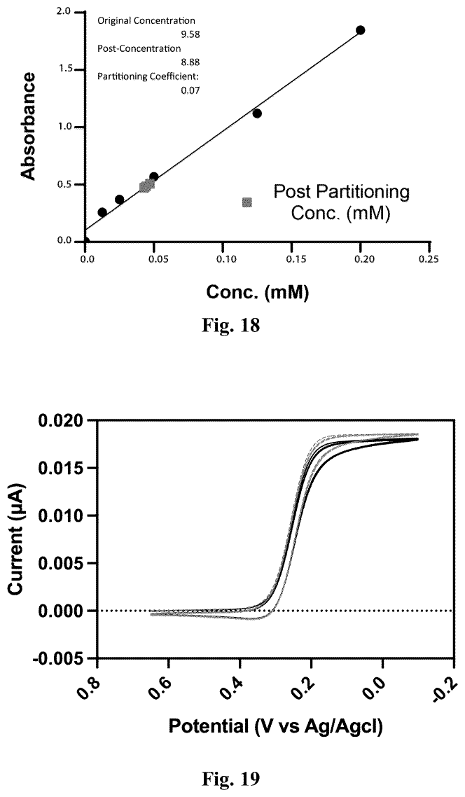

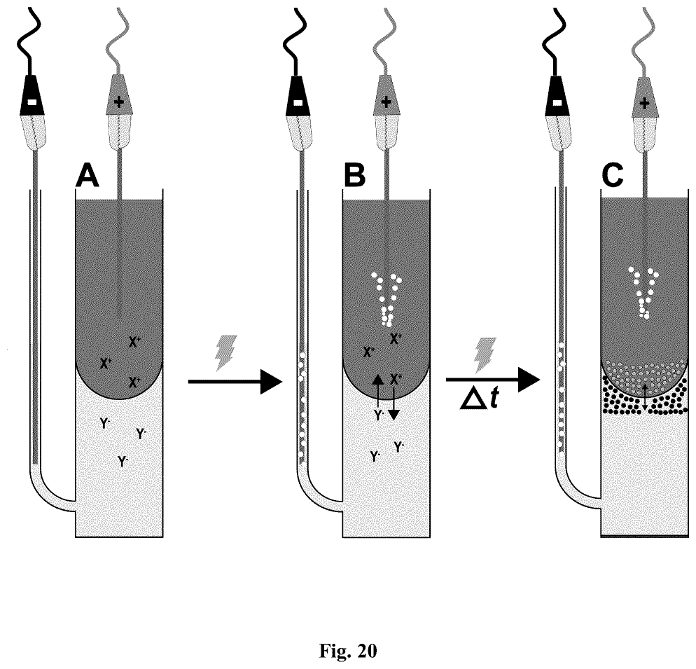

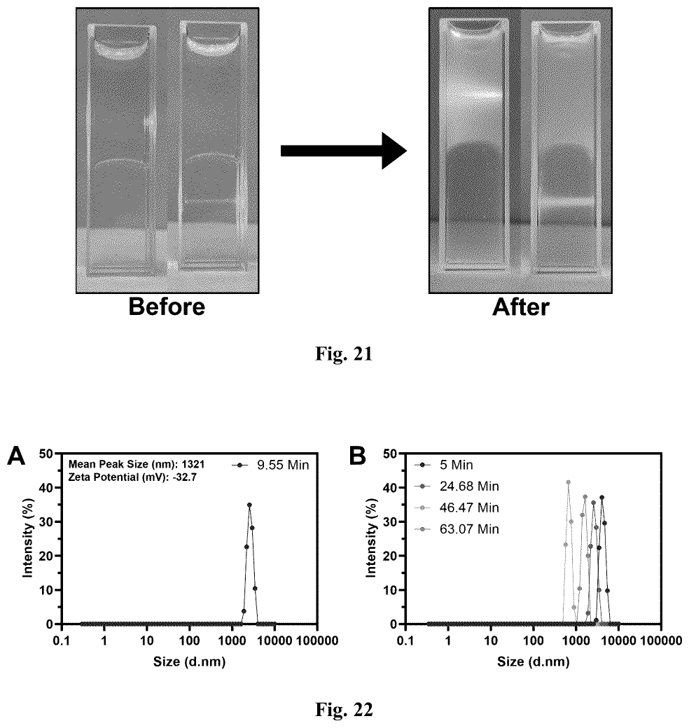

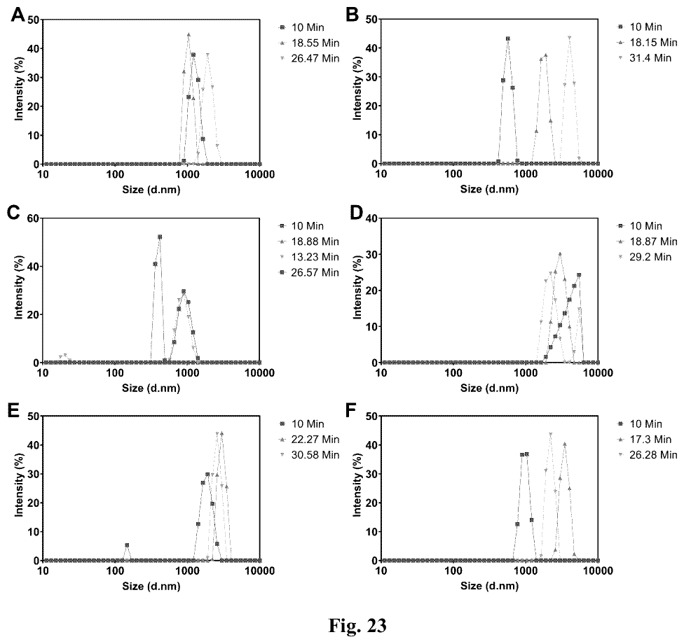

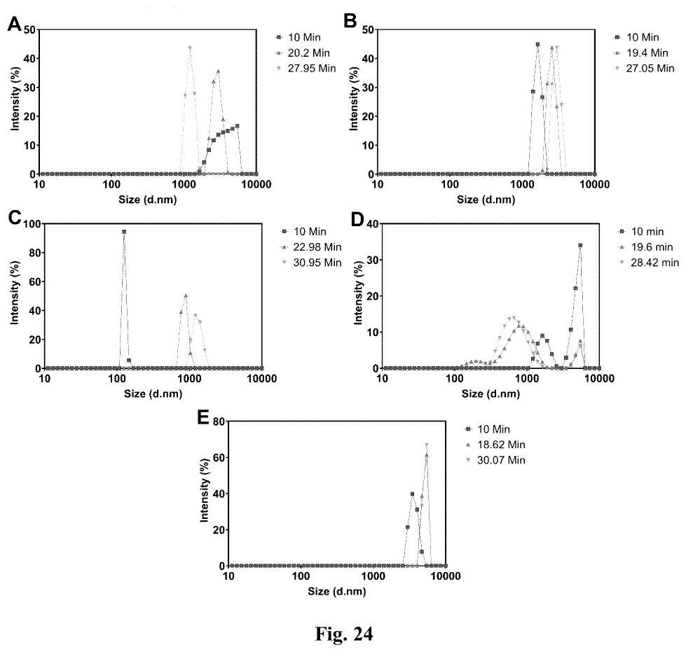

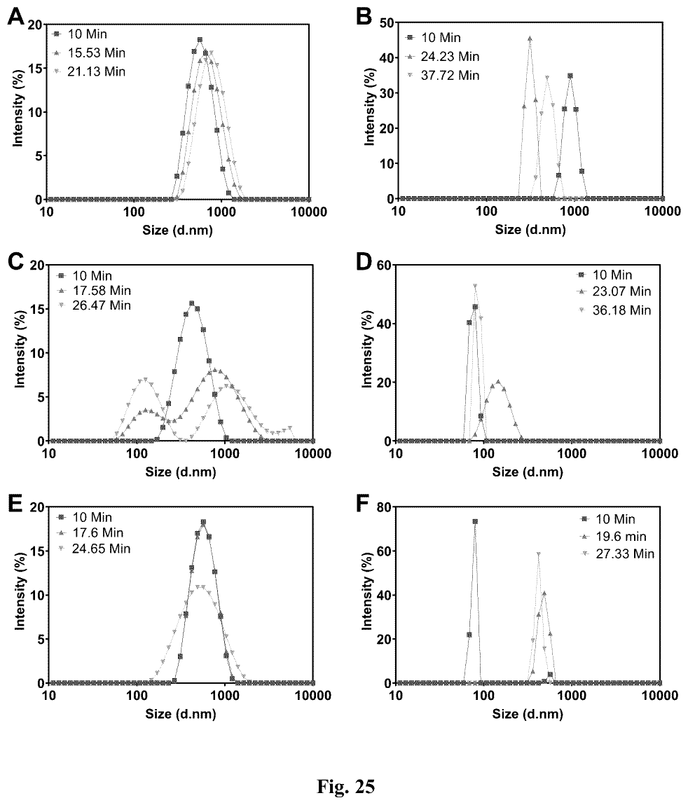

To characterize the extent of the emulsion at different points in time, droplets were identified within the same region of the image, and their areas and distances from the liquid-liquid boundary were measured using ImageJ (see FIG. 3). This method was used to compare the extent of emulsification under different conditions. FIG. 5 shows the number of identified droplets as a function of distance from the interface at four different time points in the experiment. Over time, more droplets form and do so further away from the liquid-liquid boundary. The number of droplets within 10 μm of the interface decreases with time due to coalescence (FIG. 5). This coalescence can occur both between neighboring droplets and between emulsion droplets and the bulk DCE phase. This coalescence was visually observed and substantiated by the corresponding increase in the average cross-sectional area of droplets within this range (FIG. 5). At all time points, the average droplet area decays with increasing distance from the interface.

To characterize the stability and reproducibility of the observed droplets, dynamic light scattering (DLS) measurements were performed on the droplets. An overhead stirrer was inserted into the aqueous phase and was used to induce convection in the aqueous phase without making contact with the liquid-liquid boundary. This allowed the spontaneously formed DCE droplets to be suspended in the aqueous phase. DLS measurements were performed on this suspension for over an hour, and the droplet sizes were reported in (FIG. 6). The droplets were stable for over an hour, with monomodal distributions decreasing in diameter from just over 1 μm to less than 1 μm within the hour. Additionally, images were taken of the two bulk phases during anion flux-induced emulsification without added convection for several hours, and the aqueous phase appeared cloudy due to the emulsion for a few hours after initial contact (see FIG. 7). These results suggest that these droplets can be stable for long periods of time. Furthermore, DLS measurements of four emulsions prepared under the same conditions (10 mM HAuCl₄ (aqueous phase) and 0.1 M [NBu₄][ClO₄]) (DCE) and taken at the same time after initial solution contact (5 minutes) gave reproducible droplet sizes with the average droplet diameter=1390 nm and an RSD of 12.3% (FIG. 8 and Table 2).

TABLE 2

| | | | | | Combined |
|---|---|---|---|---|---|
| | Sample | Sample | Sample | Sample | Average |
| | 1 | 2 | 3 | 4 | size |
| Average | 1230.5 | 1441.0 | 1611.8 | 1283.9 | 1391.8 |
| size (nm) | | | | | |
| Std. | 135.30 | 157.11 | 182.95 | 187.08 | 171.72 |
| deviation | | | | | |
| (nm) | | | | | |
| RSD (%) | 10.995 | 10.902 | 11.350 | 14.571 | 12.337 |

Table 2 lists the DLS data and statistical analysis for droplet size and reproducibility measurements. The average size, standard deviation, and relative standard deviation are provided for all four samples and for a combined average size.

The effect of the nature and concentration of various constituents, such as the aqueous phase, oil phase, electrolytes, phase-transfer agents, and partitioning agents, on the emulsification method were tested.

First, to ensure that the spontaneous emulsification was not simply due to the dissolution of water into DCE and vice versa, mutually saturated solutions were tested (FIG. 9). When a water-saturated DCE phase containing 0.1M [NBu₄][ClO₄] was used as the organic phase, and a DCE-saturated aqueous solution containing only 1 M NaCl was used for the aqueous phase, no emulsification was observed. It was only when HAuCl₄ was added to the DCE-saturated aqueous solution that emulsification spontaneously occurred (FIG. 9). The latter results showed no noticeable differences in emulsion behavior, compared to non-saturated solutions, suggesting that the degree of saturation of solutions prior to contact does not play a critical role in emulsion formation. Secondly, changing the added aqueous electrolyte from 1 M NaCl to 1 M KCl showed identical results (see FIG. 10), indicating that changing the supporting electrolyte has a minimal effect. However, removing the NaCl or KCl entirely from the aqueous phase showed emulsification on both sides of the liquid-liquid interface, with water droplets being observed in DCE and DCE droplets forming in water (see FIG. 11).

Spontaneous emulsification depends significantly on the partitioning agent and phase-transfer agent concentrations. The concentration dependence signifies that ionic flux plays a critical role in emulsification. For example, when either the HAuCl₄ or the [NBu₄][ClO₄] were removed from the aqueous or DCE phases, respectively, no detectable emulsification was observed (see FIGS. 12A (I) and 12B(I)). As the concentrations of these species were individually increased, a proportional increase in emulsification was observed (see FIG. 12). Either the HAuCl₄ concentration was varied from 0-10 mM, with the [NBu₄][ClO₄] concentration being held constant at 100 mM (FIG. 12A), or the HAuCl₄ concentration was held constant at 10 mM and the [NBu₄][ClO₄] concentration was varied from 0 to 100 mM (FIG. 12B). When the concentrations of HAuCl₄ was 10 mM and [NBu₄][ClO₄] was 100 mM, the greatest amount of emulsification was observed (FIG. 12C). All images were taken 10 minutes after solutions came into contact to standardize and compare emulsions within similar timeframes. A clear dependence on the concentration of both AuCl₄⁻ and [NBu₄][ClO₄] was observed quantitatively, as shown by FIGS. 12E and 12G, where greater degrees of emulsification were observed at higher concentrations. The average cross-sectional area of droplets was the largest under the conditions of the highest concentrations of HAuCl₄ or the [NBu₄][ClO₄] (FIG. 12F and FIG. 12G). So despite forming a greater number of droplets when [HAuCl₄]=5 mM, a majority of these droplets were smaller than the droplets at other concentrations, as indicated by the average cross-sectional areas. Due to the fact that droplets coalesce, analyzing the droplet counts alone is insufficient to characterize the extent of emulsification. For all cases, a size gradient was observed as a function of distance from the interface, wherein larger droplets formed closer to the liquid-liquid interface and smaller droplets extended into the bulk aqueous phase.

The other partitioning agents, KSCN and K₃[Fe(CN)₆], were tested (see FIG. 17). The other solvents, dichloromethane, chloroform, and nitrobenzene, showed similar results as DCE to induce emulsification with and without electrolyte added in the aqueous phase and using the same partitioning ion and phase transfer agent (FIG. 16).

FIG. 17D shows a generalized microscopic model for ionic flux-induced emulsification. The partitioning of ions drives the emulsification and flux of ions to the boundary. Thus, substantial ion transfer can create morphologies like that shown in the middle panels in FIG. 17D due to many water fingers. AuCl₄⁻ which strongly partitioned into the DCE phase, created DCE droplets in water (FIG. 17D), whereas other ions with lower partition coefficients, like SCN⁻ and Fe(CN)₆³⁻, did not form dense enough regions of water fingers to enclose oil droplets and thus formed only water droplets (FIG. 17B—FIG. 17C). The partition coefficient of SCN⁻ from water to DCE is 0.07 (FIG. 18, colorimetric experiment) and the partition coefficient of Fe(CN)₆³⁻ is 0.03 (FIG. 19, voltammetric experiment). These partition coefficients are orders of magnitude smaller than the corresponding partition coefficient for AuCl₄⁻, which explains the lack of DCE droplets formed in these cases.

### EXPERIMENTAL

### Electro-Emulsification:

All experiments were performed using bi-phasic systems consisting of immiscible solutions, such as 1,2-dichloroethane and water. Before experimentation, a platinum wire (r=1 mm) was sealed within a cell while maintaining an electrical connection. This allowed for external connection without perturbation of the liquid-liquid interface (FIG. 20). An organic bottom layer containing the desired phase-transfer agent, such as tetrabutylammonium perchlorate, tetrabutylammonium hexafluorophosphate, tetrabutylammonium bromide, tetrahexylammonium perchlorate, or tetrabutylammonium tetraphenylborate, was then pipetted into the cell, followed by an aqueous top layer, this order was done to limit mixing before experimentation. A secondary platinum wire (r=1 mm) was then submerged into the aqueous top layer to complete the circuit and allow for current to flow. Upon submersion, a current was then applied across the system using DC power supply. Current was maintained at 5 mA for a total duration of 5 min. Solutions were allowed to rest for an additional 5 minutes before additional experimentation or measurement.

### Dynamic Light Scattering (DLS) and Zeta Potential Measurements

The droplet sizes were measured. In these measurements, the resulting top layer and bottom layer from the prior section were allowed to rest for 5 minutes and were then transferred to a 1 cm glass cuvette. After transfer, the cuvette was inserted into the DLS instrumentation and was allowed to perform dynamic light scatter measurements to determine the size and intensity of the droplets formed during electro-emulsification. DLS measurements were taken three times, for 60 runs at 1.64 s/run, with a 120 s equilibration time and an equilibration temperature of 25° C. Zeta potential measurements were performed intermittently between each DLS measurement. Table 3 shows electro-emulsion under different experimental conditions, such as variations in the aqueous and organic phases. The average zeta potential and diameter of droplets were listed.

TABLE 3

| Aqueous | Organic | Average Size | Zeta Potential |
|---|---|---|---|
| Phase | Phase | (d · nm) N = 3 | (mV) |
| [NBu₄][Cl] | [NBu₄][PF₆] | 1209 | −70.96 |
| [NBu₄][Cl] | [NBu₄][PF₆] | 568.3 | −32.7 |
| None | [NBu₄][PF₆] | 954.1 | −1.446 |
| None | [NBu₄][PF₆] | 2211 | −41.52 |
| 1M NaOH | [NBu₄][PF₆] | 1901 | −155.3 |
| 1M NaOH | [NBu₄][PF₆] | 1039 | −17.9 |
| 1M H₂SO₄ | [NBu₄][PF₆] | 2990 | −34.76 |
| None | [NBu₄][TPB] | 125.9 | −57.08 |
| None | [NBu₄][Br] | 1635 | 70.76 |
| None | [NHx₄][ClO₄] | 3477 | −6.031 |

When the cathode was placed in the aqueous phase containing 0.1 M [NBu₄][Cl] and the anode in the organic DCE phase containing 0.1 M [NBu₄][PF₆], an average droplet diameter of 1209 nm was observed. When the cathode and anode were switched, a notable decrease in the average droplet size was observed, with an average diameter of 568.3 nm. Additionally, with the switched positioning of the cathode and anode, a more negative zeta potential was observed, with the prior case at −70.96 m V vs. the latter case at −32.7 mV. This indicated that the opposite polarity changes the composition of the droplets sufficiently to promote stability.

Emulsification was observed in the absence of an aqueous electrolyte, likely due to the auto-ionization of water. However, lower zeta potentials and larger droplet diameters were observed, indicating that the overall stability of the droplets can be affected by transferring ions. Such results indicated that the ions that are transferring are acting as stabilizing agents for the observed droplets. When testing emulsification under acidic or basic conditions, no notable time difference was observed to achieve emulsification. Differences were observed in the values obtained for the zeta potentials of the observed droplets. When the aqueous layer (cathodic) contained 1 M NaOH, and the DCE (anodic) layer contained 0.1 M [NBu₄][PF₆], a zeta potential of −155 mV was observed. For comparison, a similar system containing 1 M H₂SO₄ had a zeta potential of about −40 m V.

The different phase-transfer agents were compared to elucidate the effects of anion hydrophobicity on observed emulsion behavior. The results obtained for tetrabutylammonium tetraphenylborate ([NBu₄][TPB]), tetrabutylammonium hexafluorophosphate ([NBu₄][PF₆]), and tetrabutylammonium bromide ([NBu₄][Br]), showed a trend in the average droplet size and the observed zeta potential. Both average droplet size and zeta potential increased with increased hydrophilicity, indicating a clear correlation between the flux of the anions across the interface and observed emulsion behavior. The behavior for the emulsification of droplets in different organic solvents was tested and showed good reproducibility, as shown in FIG. 25. These results are a notable departure from current industrial methods, where the energy requirements for emulsification are on the order of hundreds of watts. The present electro-emulsification method stands in stark contrast, requiring only ˜0.1 watt, representing a technique that is a thousand times more energy efficient. The electro-emulsification method is 10³ times less energy intensive than ultrasonication and offers a practical pathway to industrially scalable emulsion synthesis without the need of complex phase-transfer agents. Thus, the emulsification can be achieved by solute flux through a liquid-liquid interface.

Those skilled in the art will recognize that numerous modifications can be made to the specific implementations described above. The implementations should not be limited to the particular limitations described. Other implementations may be possible. While the inventions have been illustrated and described in detail in the drawings and foregoing description, the same is to be considered illustrative and not restrictive in character, it being understood that only certain embodiments have been shown and described and that all changes and modifications that come within the spirit of the invention are desired to be protected.

All patents, patent application publications, journal articles, textbooks, and other publications mentioned in the specification are indicative of the level of skill of those in the art to which the disclosure pertains. All such publications are incorporated herein by reference to the same extent as if each individual publication were specifically and individually indicated to be incorporated by reference.

The term “about” can allow for a degree of variability in a value or range, for example, within 10%, within 5%, or within 1% of a stated value or of a stated limit of a range.

The terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

We claim:

1. A method for spontaneous emulsification wherein the method comprises:
mixing (i) an aqueous phase comprising a partitioning agent, which contains a partitioning anion, which determines the hydrophilicity of the partitioning agent, alone or in further combination with an electrolyte, with (ii) an oil phase comprising a phase-transfer agent, wherein the phase-transfer agent creates and promotes an interfacial flux of an anion and promotes formation of droplets at a liquid-liquid interface of the aqueous phase and oil phase, whereupon the emulsification is spontaneously formed.

2. The method of claim 1, wherein the partitioning agent is selected from chloroauric acid (HAuCl₄), potassium thiocyanate (KSCN), and potassium ferricyanide (K₃[Fe(CN)₆]).

3. The method of claim 2, wherein the partitioning agent is HAuCl₄.

4. The method of claim 1, wherein the phase-transfer agent is a quaternary ammonium salt selected from tetrabutylammonium perchlorate [NBu₄][ClO₄], tetrabutylammonium hexafluorophosphate [NBu₄][PF₆], tetrabutylammonium bromide [NBu₄][Br], tetrabutylammonium chloride [NBu₄][Cl], tetraethylammonium perchlorate [NEt₄][ClO₄], and tetrahexylammonium perchlorate [NHx₄][ClO₄].

5. The method of claim 4, wherein the phase-transfer agent is [NBu₄][ClO₄].

6. The method of claim 1, wherein the oil phase is selected from dichloroethane, dichloromethane, chloroform, and nitrobenzene.

7. The method of claim 1, wherein the electrolyte is selected from potassium chloride, sodium chloride, calcium chloride, ammonium chloride, potassium iodide, sodium iodide, and sodium perchlorate.

8. The method of claim 1, wherein the concentration of the phase transfer agent in the oil phase ranges from about 10 mM to about 100 mM.

9. The method of claim 1, wherein the concentration of the partitioning agent ranges from about 1 mM to about 10 mM.

10. A method for spontaneous electro-emulsification wherein the method comprises:
a. mixing (i) an aqueous phase, optionally comprising a phase-transfer agent, with (ii) an oil phase comprising at least one phase-transfer agent, wherein the aqueous phase and the oil phase each comprises an electrode connected to a conductive metal wire; and
b. applying a voltage,
wherein a voltage difference is created, which promotes an interfacial flux of an anion and promotes formation of droplets at a liquid-liquid interface of the aqueous phase and the oil phase, whereupon the spontaneous electro-emulsification is formed.

11. The method of claim 10, wherein the phase-transfer agent is a quaternary ammonium salt selected from tetrabutylammonium perchlorate [NBu₄][ClO₄], tetrabutylammonium hexafluorophosphate [NBu₄][PF₆], tetrabutylammonium bromide [NBu₄][Br], tetrabutylammonium chloride [NBu₄][Cl], tetraethylammonium perchlorate [NEt₄][ClO₄], tetrabutylammonium tetraphenylborate [NBu₄][TPB] and tetrahexylammonium perchlorate [NHx₄][ClO₄].

12. The method of claim 10, wherein the oil phase is selected from dichloroethane, dichloromethane, chloroform, and nitrobenzene.

13. The method of claim 10, wherein the conductive metal wire is Platinum wire.
